(19) United States
(12) Patent Application Publication
(10) Pub. No.: US 2011/0285727 A1
(43) Pub. Date: Nov. 24, 2011

(54) ANIMATION TRANSITION ENGINE

(75) Inventors: Roland Fernandez, Woodinville, WA (US); Steven M. Drucker, Bellevue, WA (US); Danyel Fisher, Seattle, WA (US); George G. Robertson, Northeast Harbor, ME (US); Alexandre Gorev, Sammamish, WA (US)

(73) Assignee: MICROSOFT CORPORATION, Redmond, WA (US)

(21) Appl. No.: 12/785,493

(22) Filed: May 24, 2010

(51) Int. Cl. G06T 15/70

(52) U.S. Cl. 345/473

(57) ABSTRACT

A method that facilitates smoothly animating content of a graphical user interface includes acts of receiving a description of a first virtual scene and receiving a description of a second virtual scene. The method also includes an act of causing an animated transition to be displayed on a display screen of a computing device between the first virtual scene and the second virtual scene at a graphical object level based at least in part upon the description of the first virtual scene and the description of the second virtual scene, wherein the animated transition at the graphical object level is an animated change of a graphical object between the first virtual scene and the second virtual scene.

### BACKGROUND

Various computer implemented tools exist that allow visualization designers to design certain visual scenes to be displayed on a display screen of a computing device (e.g., as a graphical user interface for an application and/or as a presentation). If, however, during development of an application a designer of visual scenes wishes to show some form of animation, the designer conventionally must programmatically define such animation. In other words, if the designer wishes to have a certain shape displayed and further wishes to cause such shape to become animated in some way (e.g., move across a screen, change color, etc.), the visualization designer conventionally must define the animation in a programmatic fashion.

Accordingly, developing visualizations that include some form of animation conventionally requires a significant amount of development time. Moreover, programmatically defining animation is restrictive in interactive applications, as users may act in manners that are not anticipated by the designer of visualizations. For example, unexpected user interaction may cause more graphical objects than anticipated to be subject to some form of animation. When a significant number of graphical objects are subject to animation, the animation can appear “choppy”, leading to sub-optimal aesthetics.

### SUMMARY

The following is a brief summary of subject matter that is described in greater detail herein. This summary is not intended to be limiting as to the scope of the claims.

Described herein are various technologies pertaining to an animation engine that facilitates smooth animated transitions between two virtual scenes. Such smooth animated transitions can be on the graphical object level or the scene level. Pursuant to an example, a virtual scene may comprise a graphical object of a first shape. A designer of the virtual scene may wish that the graphical object be smoothly animated in some fashion such as, but not limited to, morphing to another shape, transitioning from a first location to a second location, changing size, changing color, etc. An animation engine as will be described in greater detail herein can cause the graphical object to undergo an animated transition as desired by the designer of the virtual scenes. In another example, the transition engine can support scene level animated transitions between a first virtual scene and a second virtual scene. This can include, but is not limited to, a fade from a first virtual scene to a second virtual scene, a cut from a first virtual scene to a second virtual scene, amongst other scene level transitions.

The designer may design animated transitions for display in any suitable application, including but not limited to an application for generating presentations, an application for viewing charts and graphs, an interactive application to be executed in an Internet browser, a word processing application, an application to be executed on a client computing device that has a certain type of operating system, etc. When designing a visualization that includes an animated transition, the designer may select one of a plurality of predefined shapes that exist in a shape library that can be drawn relatively quickly. Moreover, certain animations between a subset of the shapes in the shape library can be predefined. For instance, a morph of a first shape to a second shape may be predefined such that the designer need not programmatically describe such morph. The designer can also generate predefined rules that describe how/when/where certain objects are desirably animated between virtual scenes and/or how/when/where a scene-level transition is to occur between two virtual scenes. Pursuant to an example, the designer may utilize a visual design tool and graphically place certain graphical objects at particular locations in a desired scene. The designer may then generate a rule that indicates desired transitions for such objects. This rule can be written in a high level format, such as a markup language (e.g., XML) format. Such rule may be called by name, for example. Thus, a designer of virtual scenes can design animated transition between scenes more quickly and easily than has conventionally been possible.

During execution of an application that includes a visualization that comprises an animated transition between two virtual scenes (either at the object level or scene level), a description of the first virtual scene can be generated. This description can include identifiers of graphical objects that exist in such virtual scene, locations of the graphical objects, colors of the graphical objects, etc. Additionally, a description of the second virtual scene can be generated, wherein the description includes identifiers of graphical objects that exist in the second virtual scene, locations of the graphical objects, etc. These descriptions can be analyzed and an animated transition between the two virtual scenes can be set up based at least in part upon rules generated by the designer of the virtual scenes. This setup can include type of animation, time duration of the animation, etc. As the graphical objects are predefined, several graphical objects can be simultaneously animated.

Other aspects will be appreciated upon reading and understanding the attached figures and description.

### BRIEF DESCRIPTION OF THE DRAWINGS

FIG. 1 is a functional block diagram of an example system that facilitates displaying an animated transition between two virtual scenes.

FIG. 2 is an example graphical user interface of a first virtual scene.

FIGS. 3-5 illustrate an example animated transition between virtual scenes at an object level.

FIGS. 6 and 7 illustrate a scene-level animated transition.

FIG. 8 is a flow diagram that illustrates an example methodology for displaying an animated transition between virtual scenes on a display screen of a computing device.

FIG. 9 is a flow diagram that illustrates an example methodology for causing a graphical object to morph from a first shape to a second shape.

FIG. 10 is an example computing device.

### DETAILED DESCRIPTION

Various technologies pertaining to animated transitions between virtual scenes will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

As indicated above, various technologies pertaining to animated transitions at a graphical object level and/or a scene level are described in greater detail herein. An animated transition at a graphical object level relates to an animated transition with respect to a particular graphical object that is desirably displayed in a scene. Such graphical objects may be a shape, an image or the like. Object level animated transitions contemplated herein include a morphing of a graphical object from a first shape to a second shape, wherein such morphing can be displayed as a smooth animated transition on the display screen of a computing device. Another example of a graphical object level animated transition is a cross fade from a graphical object of a first shape to a second shape. Another object level animated transition is a change of position of a graphical object from a first position to a second position, a change of color of a graphical object from a first color to a second color, some combination of the aforementioned animated transitions, etc.

A scene level animated transition pertains to an animated transition that affects an entirety of a virtual scene. Examples of scene level animated transitions include but are not limited to a fade from a first virtual scene to a second virtual scene, a fade from a first virtual scene to a black screen to a second virtual scene, a cut from a first virtual scene to a second virtual scene, a cut from a first virtual scene to a black scene to a second virtual scene, a wipe from a first virtual scene to a second virtual scene, a dissolve from a first virtual scene to a second virtual scene, etc.

Smooth animated transitions as described herein can be facilitated through implementation of an animation engine into a framework that facilitates displaying visualizations on display screens of computing devices. In an example, the framework may exist in a development platform for designing applications that can be accessed or executed through utilization of an Internet browser. That is, the framework may be included in a web application framework that can integrate multimedia graphics, animations and interactivity into a single runtime environment. In another example, the framework may be a framework utilized for rendering graphical user interfaces in applications that are configured to execute on computing devices with a particular operating system. The animation engine described herein allows designers of virtual scenes to be displayed in a display screen of a computing device to be designed quickly and efficiently, wherein such virtual scenes comprise smooth animated transitions between virtual scenes either at the graphical object level or the scene level. Specifically, the designer can be provided with a library of shapes, and a drawing engine can be preconfigured to cause such shapes to be drawn relatively quickly. These shapes can be lightweight in nature and can be grouped together in such a way that the framework mentioned above considers the group of objects to be a single object. This allows many more shapes to be simultaneously drawn and animated over several virtual scenes.

Additionally, the designer can write high level rules that indicate how animated transitions are to occur between virtual scenes either at the graphical object level or the scene level. For example, the designer can indicate that when a graphical object of a first shape is in a certain location and is selected by a user, such graphical object is to be morphed into a second shape. In another example, the designer may generate a rule that indicates that when a virtual scene comprises certain graphical objects at certain locations, a scene level transition is to occur. Moreover, the designer may generate a rule that indicates that a multi-stage transition is to occur between virtual scenes. For instance, the designer may wish to cause a column chart to be graphically transitioned to a pie chart. An example multi-stage (two-stage) transition can be described in the form of a rule written in markup language such as XML, wherein in the first stage a height of shapes in the column chart are preserved and a donut chart is generated. In the second stage the height restriction can be relaxed and the donut chart can be morphed into a pie chart. It is to be noted that the designer of the visualization need not programmatically describe each animated transition desirably displayed in an application, as the shapes are known and certain animated transitions between such shapes can be predefined in the animation engine. Thus, the designer can generate smooth animated transitions by indicating graphical objects to include in virtual scenes and conditions that cause such graphical objects to be animated in a manner desired by the designer.

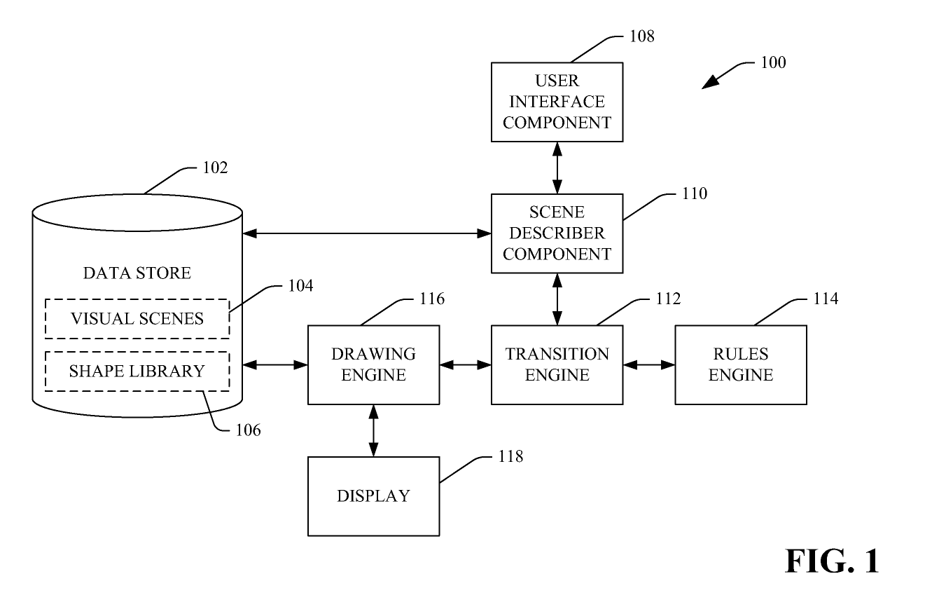

With reference to FIG. 1, an example system 100 (an animation engine) that facilitates causing animated transitions to appear smoothly on a display screen of a computing device is illustrated. The system 100 comprises a data store 102 which can be memory, a hard drive or the like. The data store 102 comprises virtual scenes 104 created by an interface designer. These virtual scenes may be desirably displayed in an application executed in a web browser, an application executing on a personal computing device that utilizes a particular operating system, on a mobile computing apparatus such as a portable telephone or multimedia player, etc. The data store 102 further comprises a shape library 106 that includes a plurality of predefined shapes. For example, the shape library 106 may include squares, circles, rectangles, triangles, stars, trapezoids, or other suitable shapes. These shapes can be defined by a plurality of vertices (e.g., a triangle can be defined by three vertices in a coordinate system). Moreover, in certain situations the shape library 106 may include shapes that are partial morphs between two shapes.

The system 100 further comprises a user interface component 108 that can be utilized by a user to interact with an application executing on a computing device utilized by the user. For instance, the user interface component 108 can be a pointing and clicking mechanism, hardware and/or software that supports touch sensitive selection of graphical objects from the display screen, etc. When a framework that comprises the system 100 is executing a program that causes a computer to display a visualization on a display screen, such framework may reach a portion of the program where an animated transition is desired (e.g., as determined through application of one or more rules). A scene describer component 110 can receive or generate descriptions of scenes that are desirably displayed on the display screen of the computing device. Specifically, the scene describer component 110 can receive/generate a description of a “before” scene (the virtual scene just prior to the animated transition) and can receive/generate an “after” scene (the virtual scene just after the animated transition). In an example, where the animated transition is desired to occur at a graphical object level, the first scene may comprise at least one graphical object and the size, shape, color, and/or location of the graphical object may have changed in the second scene. Additionally, the first scene may include one or more graphical objects that are not included in the second scene or vice versa. The description of the scenes may comprise persistent identifiers that identify graphical objects across virtual scenes. Thus, for instance, a graphical object in the first scene may be of a first shape and the same graphical object may be in the second scene but of a different shape. A persistent identifier can indicate that the graphical object is the same graphical object. The description of the scenes may also indicate color of graphical objects in the scenes, color of background in the scenes, location of graphical objects in the scenes, size of graphical objects in the scenes, amongst other data that can describe the content of the scene.

The system 100 also includes a transition engine 112 that is in communication with the scene describer component 110. Specifically, the transition engine 112 can receive descriptions of the first scene and the second scene from the describer component 110. The transition engine 112 may then set up an animated transition that causes the first scene to be smoothly transitioned to the second scene in an animated fashion.

The system 100 may also comprise a rules engine 114 that can interpret high level rules written by the designer of the visualization. These high level rules may be in a markup language format, such as XML, and can describe how graphical objects are desirably transitioned in scenes. The rules engine 114 may also implement rules to describe how scenes are to be transitioned at the scene level under certain conditions. Pursuant to a particular example, a designer may design a graphical user interface that pertains to displaying a business hierarchy. Shapes in scenes may pertain to certain individuals at different levels of the business hierarchy. Thus, a first shape (e.g., a square) can represent a manager and shapes beneath such first shape (e.g., circles) can represent individuals that report to such manager (subordinates). The designer may wish that a shape corresponding to a subordinate will graphically transition to a center of the display screen upon receipt of a selection of the shape from a user. Further, the designer may wish that the selected shape morph to a different type of shape once selected by the user (e.g., from a circle to a square). Additionally, the designer may wish that individuals that report to the selected subordinate be represented by shapes, and such shapes desirably “grow” from the shape representing the subordinate. Moreover, the designer may wish that unselected shapes transition off of the display screen. Appropriate rules can be called by the framework, and the transition engine 112 can set up the animated transition between scenes based at least in part upon the appropriate rules. The animated transition can include data that indicates type of animated transition, time duration of an animated transition, etc.

The rules again may also support optional labeling of certain types of transition rules, such as “entrance” rules, “change” rules, and/or “exit” rules. “Entrance” rules can refer to rules that cause at least one graphical objects to enter a virtual scene, “change” rules can refer to rules that cause at least one graphical object to be modified within a virtual scene, and “exit” rules can refer to rules that cause at least one graphical object to exit a virtual scene. The transition engine 112 can identify these types of rules and set up the animated transition based at least in part upon an identified type of rule.

The system 100 also includes a drawing engine 116 that is configured to draw shapes in the shape library 106 and draw such shapes in accordance with the animated transition set up by the transition engine 112. Specifically, the transition engine 112 can provide data to the drawing engine 116 regarding which shapes in the shape library 106 to draw on a display 118 of a computing device, when to draw such shapes, and where to draw such shapes. In the case of a morph, the transition engine 112 can provide data to the drawing engine 116 indicating a particular shape to draw when starting the morph (a “before” shape), a particular shape to draw at the end of the morph (an “after” shape), and an amount of time desired to complete the morph on the display 118. The drawing engine 116, for morphs between certain shapes, can have prior knowledge of how to morph between such shapes. More particularly, the drawing engine 116 can have knowledge of locations of vertices of the before shape as well as location of vertices of the after shape. The drawing engine 116 can also know how to move the vertices appropriately to create an illusion of the morph. The distances of movement of the vertex can be adjusted during each step of the animated morph, thereby allowing morphs to occur in constant time. Such movement of the vertices may be a percentage of a total distance of movement between vertices for the before shape and the after shape, and the percentage of the total distance can depend upon a speed in which the system 100 is running, thereby allowing the morph to complete in a fixed period of time. In an example, the animation may be displayed on the display 118 at a frame rate of 30 frames per second. For shapes that do not morph well, the transition engine 112 can request that the drawing engine 116 cause an animated transition to be displayed from a first shape to a second shape through utilization of a fade, a cross-fade, or other suitable animation technique. The transition engine 112 can also inform the drawing engine 116 of how quickly to animate a change in location of a graphical object/shape from a first location in the first scene to a second location in the second scene (if it is desired that the graphical object/shape transition in such manner). Similarly, the transition engine 112 can indicate that colors of graphical objects are desirably changed between the first scene and the second scene. The drawing engine 116, for instance, can interpolate in the RGB spectrum to cause such color change to be displayed on the display 118 in a smooth fashion.

Of course, as indicated above, the rules engine 114 can indicate that a desired transition between the first scene and the second scene is at the scene level. The transition engine 112 can set up such animated transition and inform the drawing engine 116 of the animated transition. The drawing engine 116 may then execute the animated transition at the scene level. The drawing engine 116 can benefit from a specialization which includes only drawing shapes, not supporting hit testing, the lightweight description of the shapes in memory, etc. For example, in one embodiment, shapes can be drawn using set pixel operations on a bitmap which can be faster than conventional drawing of shapes. Additionally or alternatively, the drawing engine 116 can draw/morph shapes on a graphical processing unit (GPU) using hardware instancing and weighted selection in shader code. Further, transition animations described by the transition engine 112 can be executed by the drawing engine 116 such that sounds are played simultaneously with an animated transition shown in the display 118. Moreover, a framework executing the application that comprises the system 100 can at any time override animated transitions indicated by the transition engine 112. Thus, higher level rules of the framework can override actions of the system 100.

Additional functionality of the transition engine 112 will now be described. As indicated above, the system 100 can be integrated with an application that is utilized to develop and display visual scenes, wherein an application can call the components of the system 100 when appropriate. The transition engine 112, however, can also call back to the application to obtain custom transition information when desired pertaining to a certain graphical object or objects.

Furthermore, the transition engine 112 can specify an amount of time within which a particular animated transition is desirably completed, and can instruct the drawing engine 116 to perform the transition within the specified amount of time. The particular animated transition can be specified explicitly by an application or specified through one of the aforementioned rules. In some cases and for some animations, an amount of time required to perform the desired animated transition may be greater than the specified amount of time. If such a case occurs, the transition engine 112 can set up the animated transition utilizing a “fallback” animation that may be faster than the desired animation.

Additionally, in some instances, it may be desired to have multiple object-level animated transitions occur at substantially the same time; however, in some cases simultaneously performing such multiple object-level animated transitions may take too much time and/or consume too many computing resources. In such a case, the transition engine 112 can set up a scene-level animated transition (e.g., a predefined “fallback” scene) to ensure that the scene-level animated transition occurs within a specified amount of time.

Similarly, in some instances it may be desirable to perform a certain scene-level animated transition; however, performing such scene-level animated transition may take too much time. Accordingly, the transition engine 112 can set up a scene-level animated transition that occurs faster than the desired scene-level animated transition (e.g., setting up a “cut” instead of a “fade”).

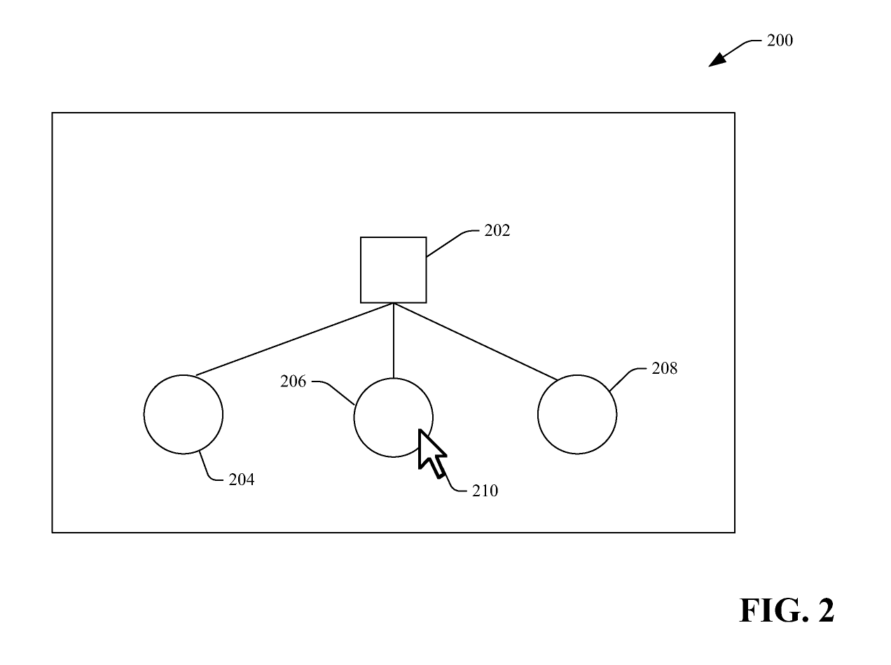

Referring now to FIG. 2, an example graphical user interface 200 that is designed by a designer of a visualization is illustrated. In this example, the graphical user interface 200 may correspond to an application that allows a user of such application to traverse through a hierarchy of individuals in a business environment. The graphical user interface 200 comprises a first graphical object 202 that is representative of a manager at a particular level in a business hierarchy. The graphical user interface 200 further comprises graphical objects 204, 206 and 208 that are representative of subordinates of the manager represented by the graphical object 202. The graphical object 202 is a first shape (a square) and indicates that the graphical object 202 represents a manager and the graphical objects 204-208 are a second shape (circles) and indicate that such graphical objects represent subordinates of the manager. The user can employ a pointing and clicking mechanism 210 to select one or more of these graphical objects 202-208 on the graphical user interface 200. Selection of one of the graphical objects 204-208 may desirably cause an animated transition of the graphical objects 202-208 to occur. In an example, upon selection of the graphical object 206 it may be desirable to show such graphical object 206 as representing a manager and may be further desirable to show graphical objects that represent individuals that report to such manager. A rule can indicate that the graphical object 202 move upwards and off the screen and the graphical objects 204-208 move to the left and right of the screen, respectively.

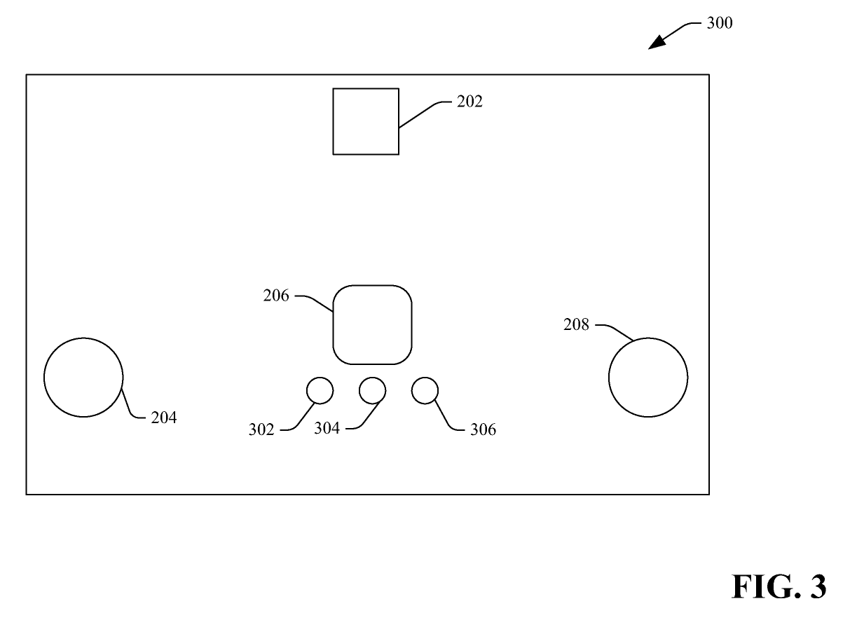

With reference now to FIG. 3, a graphical user interface 300 that represents a portion of the animated transition that is undertaken by the system 100 is shown. The graphical object 206 can begin to morph from the first shape to the second shape. That is, the graphical object 206 may have a persistent identifier associated therewith such that the transition engine can determine that the designer wishes that the graphical object 206 is morphed from the first shape to the second shape (a circle to a square). The graphical object 202 is moving upwards off the screen and the graphical objects 204 and 206 are moving to left and right of the screen, respectively. Meanwhile, graphical objects 302, 304 and 306 are shown as growing out of the graphical object 206. These graphical objects 302-306 may represent individuals that report to the individual represented by the graphical objects 206.

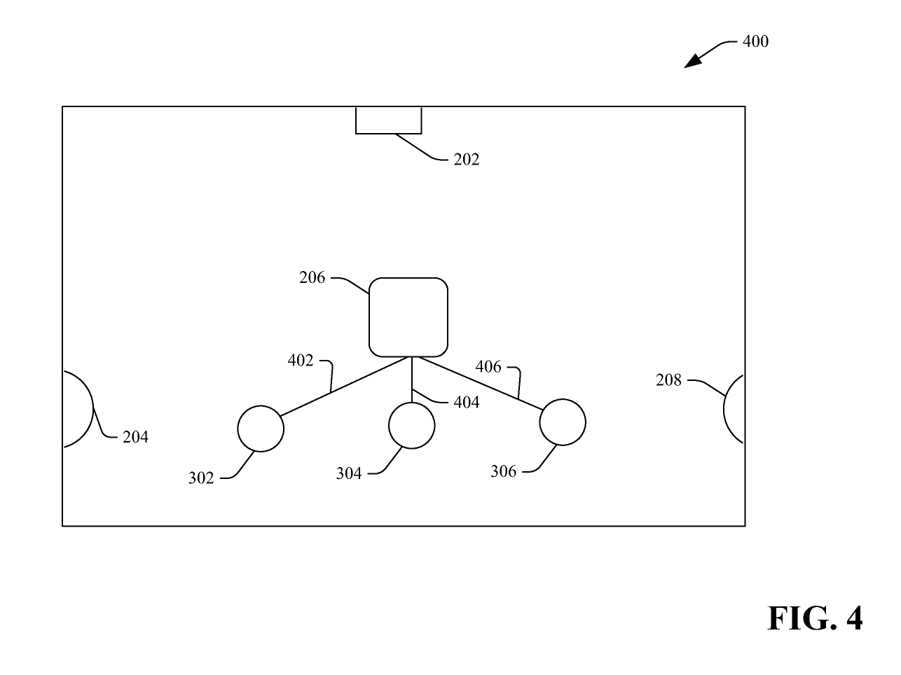

With reference now to FIG. 4, a graphical user interface 400 that shows another portion of the animated transition is illustrated. As can be seen the graphical object 206 further transitions from a circle to a square, and the graphical object 202 moves further upward. The graphical objects 204 and 208 move to the left and right of the screen, respectively. The graphical objects 302-306 continue to become enlarged and grow away from the graphical object 206. Moreover, lines 402, 404 and 406 can be drawn to illustrate the relationship between the graphical object 206 and the graphical objects 302-306.

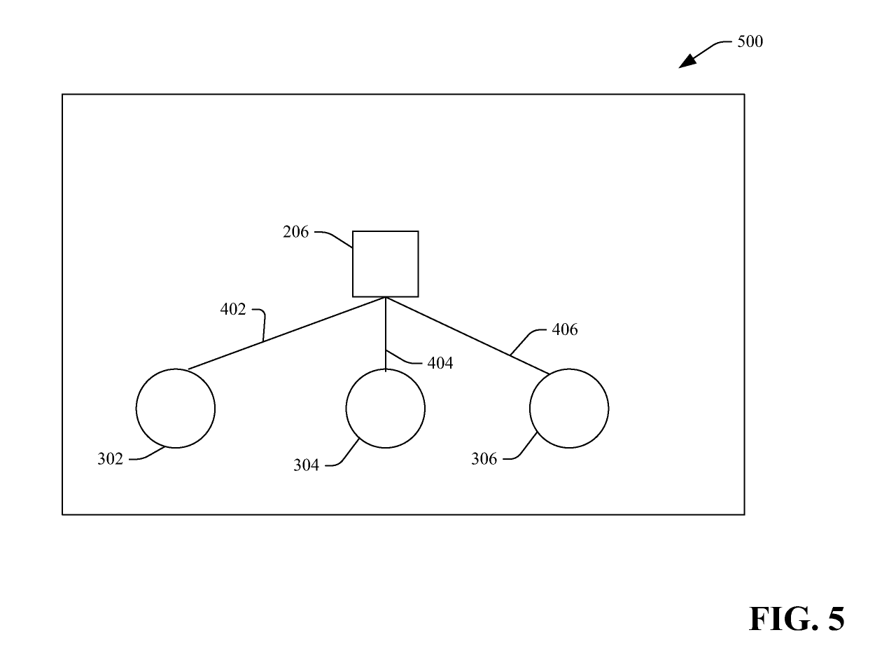

Turning now to FIG. 5, yet another graphical user interface 500 that represents a portion of the animated transition is illustrated. The graphical user interface 500 includes the graphical object 206 after it has been morphed into a square. The graphical objects 302-306 have “grown” to full size and lines 402-406 indicating a relationship between the person represented by the graphical object 206 and the people represented by the graphical objects 302-306 illustrate the relationship between the person represented by the graphical object 206 and the people represented by the graphical objects 302-306. The graphical objects 202, 204 and 208 have transitioned off of a viewable area of the screen. The animated transitions shown in FIGS. 2-5 are at the object level. As indicated above, however, a transition may be undertaken at a scene level.

Furthermore, the animated transitions shown in FIGS. 2-5 have all described a single stage transition; that is, the graphical objects described above each began movement/morphing at approximately a same point in time. It is to be understood, however, that alternatively an animated transition may occur in two or more stages. For example, each graphical object that represents a subordinate of a manager may exit a scene during a first stage (which may take ½ of a second). During a second stage, additional animations may occur (which may also be specified to occur within a certain window of time).

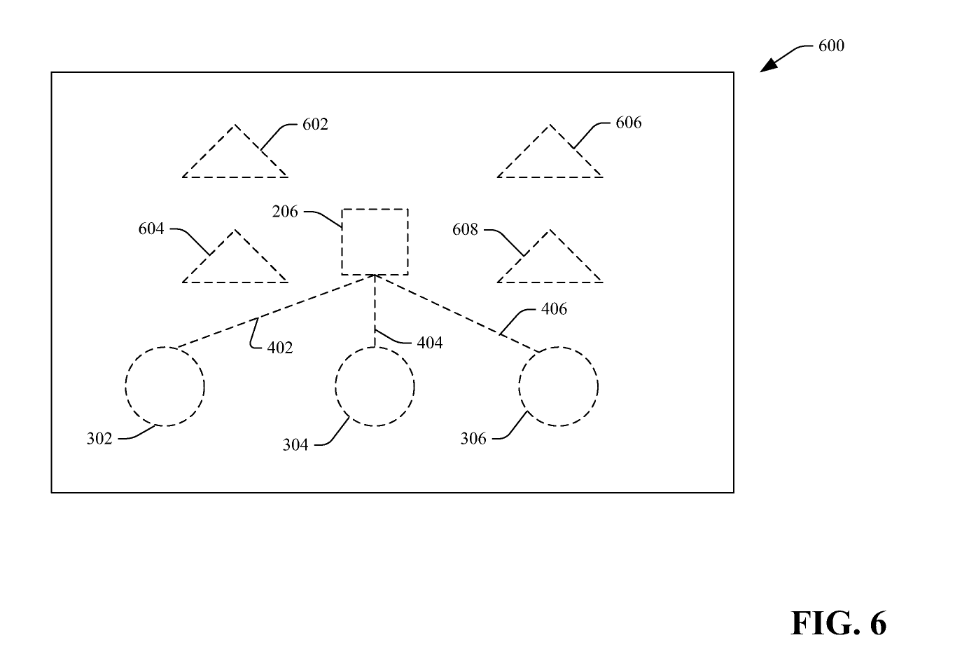

With reference now to FIG. 6, an animated transition at a scene level is illustrated. A graphical user interface 600 comprises the graphical objects 206, 302, 304 and 306 as indicated above as well as the lines 402-406 that represent relationships between the graphical objects. A user may have taken some action with respect to a portion of the application such that the graphical objects 206, 302-306 and lines 402-406 fade out as new graphical objects 602-608 are displayed on the graphical user interface 600. For example a user may have pressed a menu button or performed some other action that causes the scene level transition to be undertaken.

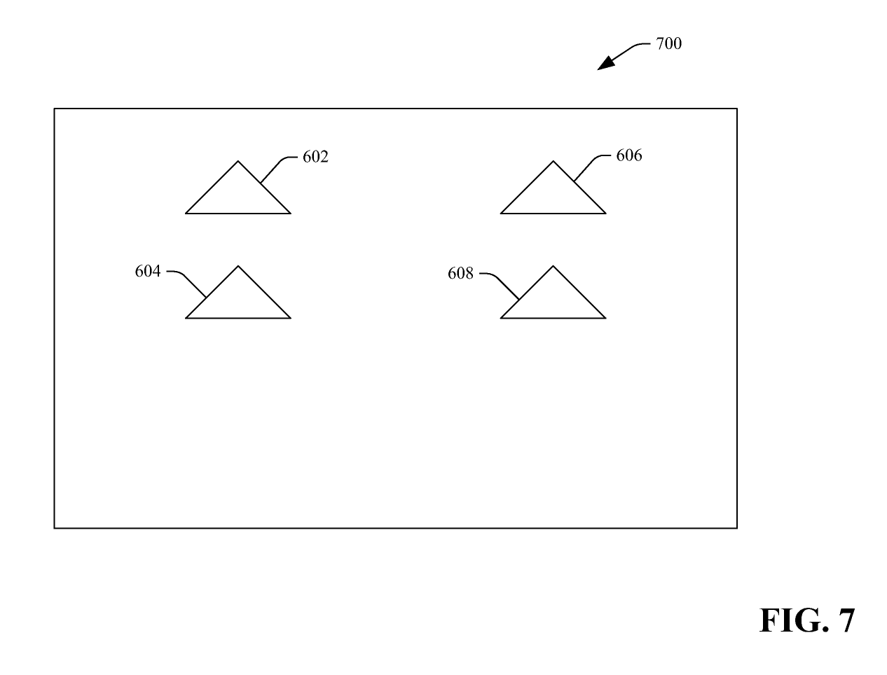

Referring now to FIG. 7, a graphical user interface 700 that shows completion of the scene-level animated transition is illustrated. In this graphical user interface 700, the graphical objects 206, 302-306 and lines 402-406 have completely faded out while the graphical objects 602-608 have completely faded in to the graphical user interface 700.

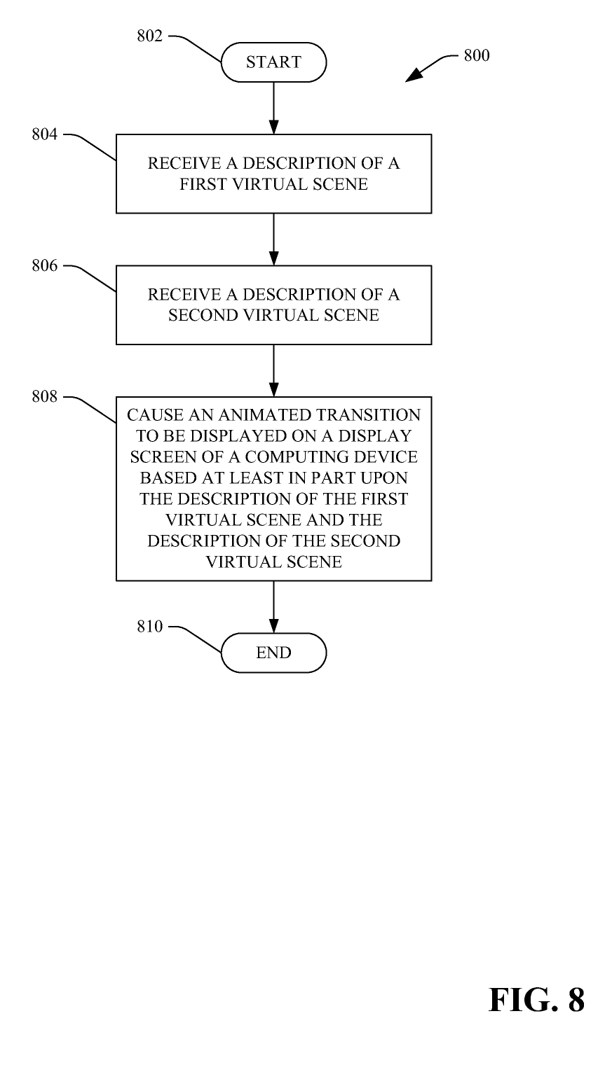

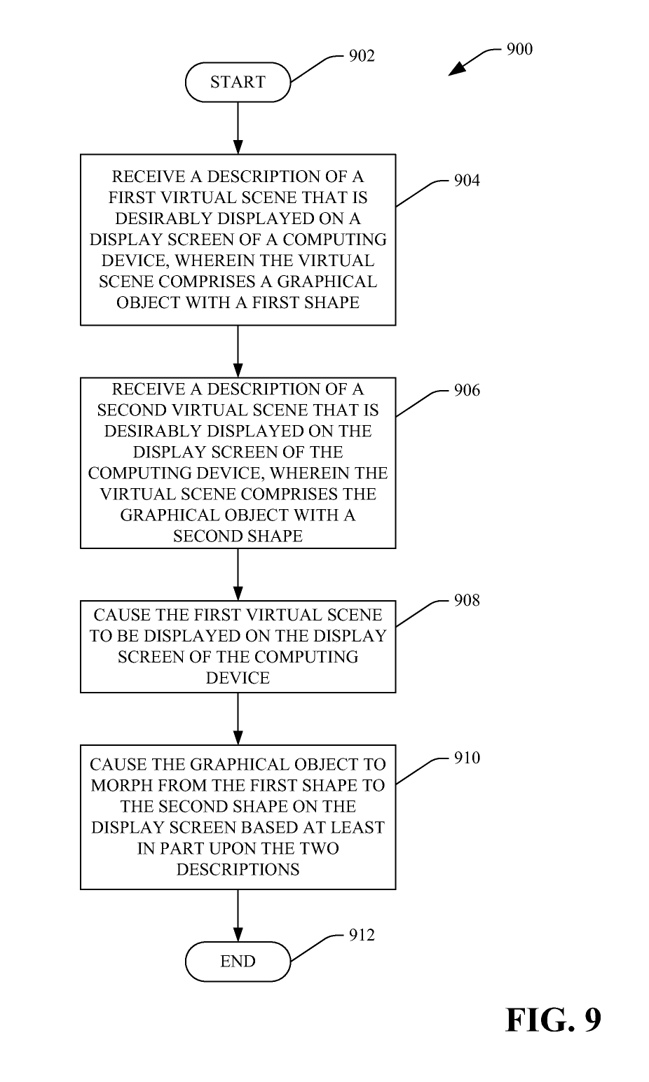

With reference now to FIGS. 8-9, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Referring now to FIG. 8, a methodology 800 that facilitates causing an animated transition to be displayed smoothly on a display screen of a computing device is illustrated. The methodology 800 begins at 802, and at 804 a description of a first virtual scene is received. This description can include identifiers of graphical objects in the first virtual scene, size of graphical objects in the first virtual scene, shapes of graphical objects in the first virtual scene, colors of graphical objects in the first virtual scene, amongst other data.

At 806, a description of a second virtual scene is received. The second virtual scene can be different from the first virtual scene such that different graphical objects appear in the second virtual scene, location of graphical objects in the first virtual scene have changed in the second virtual scene, shapes of one or more graphical objects in the first virtual scene have changed in the second virtual scene, etc.

At 808, a graphical animated transition is caused to be displayed on a display screen of a computing device, wherein the animated transition is between the first virtual scene and the second virtual scene. The animated transition can be at the graphical object level such that an animated transition occurs with respect to a graphical object in the first virtual scene and the second virtual scene. In other words, the animated transition at the object level is an animated change of the graphical object between the first virtual scene and the second virtual scene. Such animated change may be a change of location, a change of color, a change of shape, etc. The methodology 800 completes at 810.

With reference now to FIG. 9, a methodology 900 that facilitates smoothly displaying an animated morph between a first shape and a second shape on a display screen of the computing device is illustrated. The methodology 900 starts at 902, and at 904 a description of a first virtual scene that is desirably displayed on a display screen of a computing device is received. The description of the first virtual scene can include an indication that a graphical object has a first shape, and the description of the first virtual scene can also include a persistent identifier that uniquely identifies the graphical object.

At 906, a description of a second virtual scene that is desirably displayed on the display screen of the computing device immediately subsequent to the display of the first virtual scene on the display screen of the computing device is received. As used herein, “immediately subsequent” means that the second scene is desirably shown subsequent to the first scene after a smooth animated transition of at least one graphical object in the first scene to the second scene is undertaken.

At 908, the first virtual scene is caused to be displayed on the display screen of the computing device. At 910, at least one graphical object in the first scene and the second scene is caused to morph from a first shape to a second shape on the display screen of the computing device based at least in part upon the description of the first virtual scene and the description of the second virtual scene. Thus, subsequent to completion of the morph on the graphical object from the first shape to the second shape, the second virtual scene is displayed on the display screen of the computing device. The methodology 900 completes at 912.

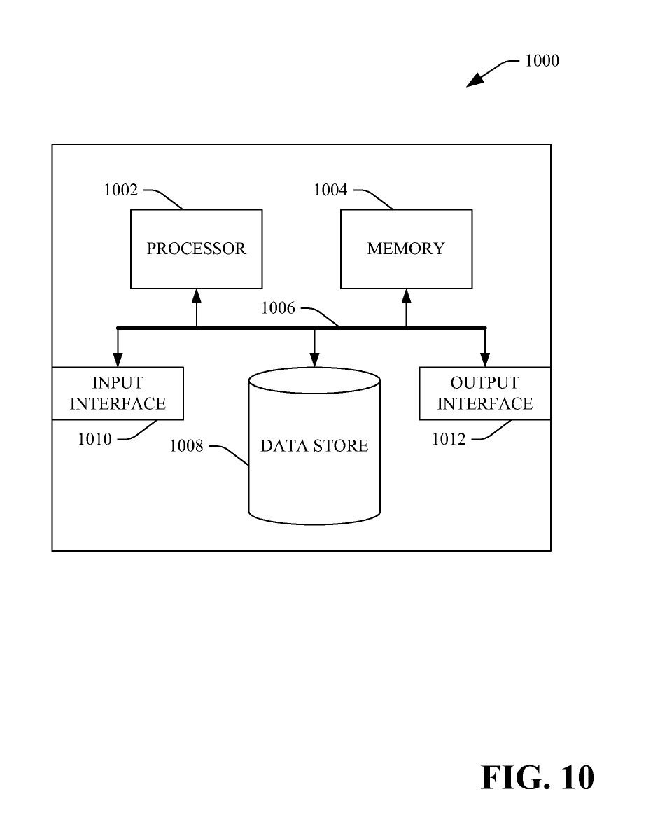

Now referring to FIG. 10, a high-level illustration of an example computing device 1000 that can be used in accordance with the systems and methodologies disclosed herein is illustrated. For instance, the computing device 1000 may be used in a system that supports smoothly transitioning between virtual scenes desirably displayed on a computing device. In another example, at least a portion of the computing device 1000 may be used in a system that supports morphing a graphical object from a first shape to a second shape. The computing device 1000 includes at least one processor 1002 that executes instructions that are stored in a memory 1004. The memory 1004 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store graphical objects, scenes, descriptions of scenes, etc.

The computing device 1000 additionally includes a data store 1008 that is accessible by the processor 1002 by way of the system bus 1006. The data store 1008 may be or include any suitable computer-readable storage, including a hard disk, memory, etc. The data store 1008 may include executable instructions, graphical objects, shapes, rules, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

Additionally, while illustrated as a single system, it is to be understood that the computing device 1000 may be a distributed system. Thus, for instance, several devices may be in communication by way of a network connection and may collectively perform tasks described as being performed by the computing device 1000.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method that facilitates smoothly animating content of a graphical user interface, comprising:
receiving a description of a first virtual scene;
receiving a description of a second virtual scene; and
causing an animated transition to be displayed on a display screen of a computing device between the first virtual scene and the second virtual scene at a graphical object level based at least in part upon the description of the first virtual scene and the description of the second virtual scene, wherein the animated transition at the graphical object level is an animated change of a graphical object between the first virtual scene and the second virtual scene.

2. The method of claim 1, further comprising:
subsequent to receiving the description of the second virtual scene, receiving a description of a third virtual scene; and
causing a scene-level animated transition to be displayed on the display screen of the computing device between the second virtual scene and the third virtual scene.

3. The method of claim 2, wherein the scene-level animated transition is one of a fade from the second virtual scene to the third virtual scene, a fade from the second virtual scene to a blank scene to the third virtual scene, a cut from the second virtual scene to the third virtual scene, a cut from the second virtual scene to a blank scene followed by a cut to the third virtual scene, a dissolve of the second virtual scene to the third virtual scene, or a wipe from the second virtual scene to the third virtual scene.

4. The method of claim 1, wherein the animated change of the graphical object between the first virtual scene and the second virtual scene is a morph of the graphical object from a first shape to a second shape.

5. The method of claim 1, wherein the animated change of the graphical object between the first virtual scene and the second virtual scene comprises altering position of the graphical object between the first virtual scene and the second virtual scene.

6. The method of claim 1, wherein the animated change of the graphical object between the first virtual scene and the second virtual scene comprises a fade of the graphical object from a first shape to a second shape.

7. The method of claim 1, wherein the description of the first virtual scene and the second virtual scene comprises a persistent identifier that identifies the graphical object in the first virtual scene and the second virtual scene.

8. The method of claim 1, further comprising receiving a rule that indicates that the animated transition is to be displayed on the display screen based at least in part upon the description of the first virtual scene and the description of the second virtual scene.

9. The method of claim 8, wherein the rule is composed in a markup language.

10. The method of claim 1, further comprising:
calling an application to obtain information pertaining to the animated transition; and
causing the animation to be displayed on the display screen based at least in part upon the information pertaining to the animated transition received from the application.

11. The method of claim 1, further comprising causing the animated transition to be displayed in a graphical user interface in an Internet browser.

12. The method of claim 1, further comprising:
determining that an amount of time needed to perform a first animated transition pertaining to the graphical object is above a threshold; and
selecting the animated transition that is caused to be displayed on the display screen of the computing device subsequent to determining that the amount of time needed to perform the first animated transition is above the threshold.

13. A computing apparatus, comprising:
a processor; and
a memory that comprises components that are executed by the processor, wherein the components comprise:
a scene describer component that describes virtual scenes to be displayed on a display screen of the computing apparatus in an application executing on the computing apparatus, wherein the virtual scenes comprise a first virtual scene and a second virtual scene, wherein the first virtual scene comprises a graphical object; and
a transition engine that receives a description of the first virtual scene and a description of the second virtual scene and sets up an animated transition of the graphical object between the first virtual scene and the second virtual scene based at least in part upon the description of the first virtual scene and the description of the second virtual scene.

14. The computing apparatus of claim 13, wherein the components further comprise a rules engine that facilitates implementation of a user-defined rule, wherein the transition engine receives the user-defined rule and sets up the animated transition of the graphical object between the first virtual scene and the second virtual scene based at least in part upon the user-defined rule.

15. The computing apparatus of claim 14, wherein the user-defined rule is written in a markup language.

16. The computing apparatus of claim 13, wherein the components further comprise a drawing engine that causes the animated transition to be displayed on the display screen of the computing apparatus.

17. The computing apparatus of claim 16, wherein the animated transition comprises transition of the graphical object off of a viewable area of the display screen.

18. The computing apparatus of claim 16, wherein the animated transition is an animated morph of the graphical object from a first shape in the first virtual scene to a second shape in the second virtual scene.

19. The computing apparatus of claim 13, wherein the transition engine is further configured to receive a description of a third virtual scene and sets up a scene-level transition between the second virtual scene and the third virtual scene.

20. A computer-readable medium comprising instructions that, when executed by a processor, cause the processor to perform acts comprising:
receiving a description of a first virtual scene that is desirably displayed on a display screen of a computing device, wherein the description of the first virtual scene comprises an indication that a graphical object has a first shape, wherein the description of the first virtual scene comprises a persistent identifier that identifies the graphical object;
receiving a description of a second virtual scene that is desirably displayed on the display screen of the computing device immediately subsequent to display of the first virtual scene on the display screen of the computing device, wherein the description of the second virtual scene comprises an indication that the graphical object has a second shape, wherein the description of the second virtual scene comprises the persistent identifier that identifies the graphical object;
causing the first virtual scene to be displayed on the display screen of the computing device; and
causing the graphical object to morph from the first shape to the second shape on the display screen of the computing device based at least in part upon the description of the first virtual scene and the description of the second virtual scene, wherein subsequent to completion of the morph the second virtual scene is displayed on the display screen of the computing device.
